(19) United States
(12) Patent Application Publication
(10) Pub. No.: US 2017/0078117 A1
(43) Pub. Date: Mar. 16, 2017

(54) METHOD AND APPARATUS FOR CHANNEL ESTIMATION FOR THREE-PHASE PLC SYSTEMS

(71) Applicant: Enphase Energy, Inc., Petaluma, CA (US)

(72) Inventors: Fenghua Liu, Portland, OR (US); Jianzhong Huang, San Jose, CA (US); Kennan Laudel, San Jose, CA (US)

(21) Appl. No.: 15/262,470

(22) Filed: Sep. 12, 2016

Related U.S. Application Data
(60) Provisional application No. 62/217,574, filed on Sep. 11, 2015.

(51) Int. Cl. H04L 25/02; H04B 3/54

(52) U.S. Cl. CPC H04L 25/0242; H04B 3/54

(57) ABSTRACT

A method and apparatus for channel estimation for a three-phase communication system. In one embodiment, the method comprises generating a first plurality of preamble patterns for use in a first data stream of two independent data streams; generating a second plurality of preamble patterns for use in a second data stream of the two independent data streams; transmitting the first and the second data streams via a communications channel comprising a three-wire three-phase system; receiving a version of the first data stream comprising the first plurality of preamble patterns and a version of the second data stream comprising the second plurality of preamble patterns; and generating, based on the received version of the first plurality of preamble patterns and the received version of the second plurality of preamble patterns, a channel estimation matrix for estimating the imbalance of the communications channel.

### CROSS-REFERENCE TO RELATED APPLICATIONS

This application claims benefit of U.S. provisional patent application Ser. No. 62/217,574, entitled “Method and Apparatus for Channel Estimation for Three-Phase PLC Systems” and filed Sep. 11, 2015, which is herein incorporated in its entirety by reference.

### BACKGROUND OF THE INVENTION

Field of the Invention

Embodiments of the present invention generally relate to power line communications and, more particularly, to channel estimation and compensation for three-phase power line communications.

Description of the Related Art

In three-phase power line communication (PLC) systems, the attenuation and phase shift for each of the three phases are generally different. As a result of the different amplitude attenuations and phase shifts introduced among the three-phase power lines, the transmitted quadrature signals I and Q will be distorted at the receiver side. Further, in practice each of the three phases may be mis-wired, resulting in an imbalance. As a result, channel estimation and compensation are needed in order to prevent significant system performance degradation.

Therefore, there is a need in the art for an effective technique for channel estimation and compensation in three-phase PLC.

### SUMMARY OF THE INVENTION

Embodiments of the present invention generally relate to a method and apparatus for channel estimation for three-phase PLC systems substantially as shown in and/or described in connection with at least one of the figures, as set forth more completely in the claims.

Various advantages, aspects and novel features of the present disclosure, as well as details of an illustrated embodiment thereof, will be more fully understood from the following description and drawings.

### BRIEF DESCRIPTION OF THE DRAWINGS

So that the manner in which embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is block diagram of a system for power conversion in accordance with one or more embodiments of the present invention;

FIG. 2 is a block diagram of a system for power line communications in accordance with one or more embodiments of the present invention;

FIG. 3 is a logical block diagram of a three-phase PLC system in accordance with one or more embodiments of the present invention;

FIG. 4 is a logical block diagram of a three-phase channel according to one or more embodiments where precoding is used (i.e., a precoded mode);

FIG. 5A is a logical block diagram depicting a sub-channel model in accordance with one or more embodiments of the present invention;

FIG. 5B is a logical block diagram depicting another sub-channel model in accordance with one or more embodiments of the present invention;

FIG. 6 is a block diagram depicting a complex down-conversion, low pass filtering, and linear transformation to obtain the channel matrix parameters A, B, C and D in accordance with one or more embodiments of the present invention;

FIG. 7 is a logical block diagram of a three-phase channel according to one or more embodiments where precoding is not used (i.e., a direct mode);

FIG. 8 depicts the I, Q preamble structures for packet detection and channel estimation in accordance with one or more embodiments of the present invention;

FIG. 9 depicts the I, Q preamble structures for packet detection and channel estimation in accordance with one or more other embodiments of the present invention;

FIG. 10 is a block diagram depicting down-conversion at the receiver in accordance with one or more embodiments of the present invention where the precoding mode is used;

FIG. 11 depicts the channel compensation in one or more embodiments of the present invention where the precoding mode is used;

FIG. 12 is a simplified block diagram for performing channel estimation based on the preamble in accordance with one or more embodiments of the present invention;

FIG. 13 is a simplified block diagram for performing channel compensation based on the channel parameters {A,B,C,D} from the channel estimation in accordance with one or more embodiments of the present invention;

FIG. 14 depicts the channel compensation in one or more embodiments of the present invention where the direct mode is used; and

FIG. 15 is a flow diagram of a method for channel estimation and compensation for three-phase PLC in accordance with one or more embodiments of the present invention.

### DETAILED DESCRIPTION

Embodiments of the present invention include a method and apparatus for estimating three-phase power line communication (PLC) channels. The channel estimation described herein is a low-complexity technique (no divider is involved) that works in a low signal-to-noise ratio (SNR) and can automatically handle mis-wiring in practice as well as estimate the three-phase PLC channel within the preamble (it is a packet-by-packet channel estimation). System performance can be predicted based on the estimated channels, which can provide guidance for three-phase mode selection (one stream mode or two stream mode).

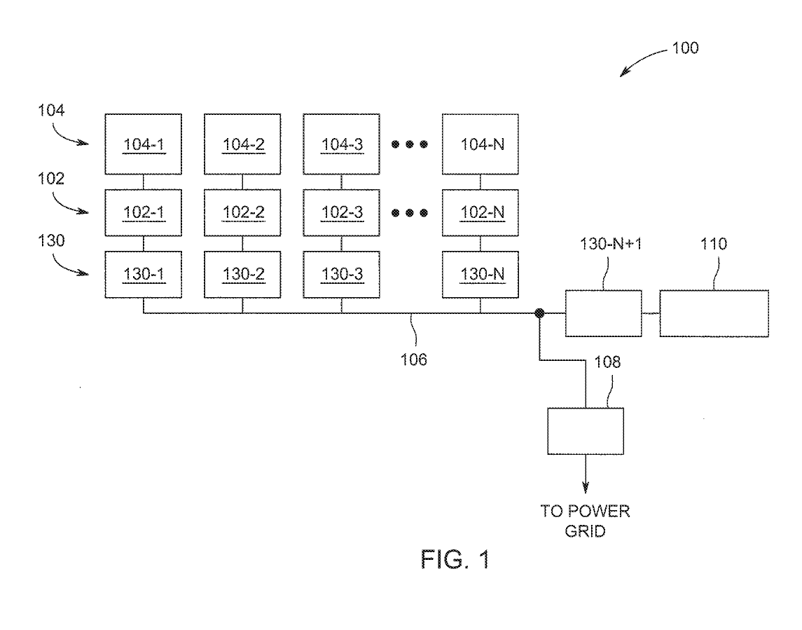

FIG. 1 is a block diagram of a distributed generator (DG) system 100 for power conversion in accordance with one or more embodiments of the present invention. This diagram only portrays one variation of the myriad of possible system configurations and devices that may utilize the present invention. The present invention can be utilized by any device for three-phase power line communication (PLC), and can function in a variety of distributed environments and systems requiring communications over three-phase power lines.

The system 100 comprises a plurality of power conditioning units (PCUs) 102-1, 102-2 . . . 102-N, collectively referred to as PCUs 102; a plurality of power modules 104-1, 104-2 . . . 104-N, collectively referred to as power modules 104; a plurality of PLC transceivers (PLCTs) 130-1, 130-2 . . . 130-N, and 130-N+1, collectively referred to as PLCTs 130; a three-phase AC power line 106; a load center 108; and controller 110.

Each PCU 102-1, 102-2 . . . 102-N (collectively “PCUs 102”) is coupled to a power module 104-1, 104-2 . . . 104-N (collectively “power modules 104”), respectively, in a one-to-one correspondence; alternatively, multiple power modules 104 may be coupled to one or more of the PCUs 102, or the power modules 104 may all be coupled to a single PCU 102 (i.e., a single centralized PCU).

Each PCU 102-1, 102- . . . 102-N is additionally coupled to a PLCT 130-1, 130-2 . . . 130-N, respectively, in a one-to-one correspondence, and the controller 110 is coupled to the PLCT 130-N+1. In some alternative embodiments, one or more of the PLCTs 130-1, 130-2 . . . 130-N may be part of the corresponding PCU 102-1, 102-2 . . . 102-N, and/or the PLCT 130-N+1 may be part of the controller 110. The PLCTs 130-1, 130-2 . . . 130-N+1 may be collectively referred to as “PLCTs 130”.

The PLCTs 130 are coupled to the three-phase AC power line 106 and can communicate using PLC via the AC power line 106. The AC power line 106 is further coupled to the load center 108 which houses connections between incoming three-phase AC power lines from, for example, a commercial AC power grid distribution system and the AC power line 106.

In some embodiments the power modules 104 may be DC power modules such as renewable energy sources (e.g., photovoltaic (PV) modules or other solar power sources, wind farms, hydroelectric systems, or the like), another type of power conditioner, batteries, or the like. The PCUs 102 are power conditioners that transform a received input power to a different output power. For example, the PCUs 102 may be DC-AC inverters that receive DC power from the power modules 104 and couple the generated AC power to the AC power line 106, or the PCUs 102 may receive AC power from the AC power line 106 and convert the received AC power to DC power which is coupled to the power modules 104. Alternatively, the PCUs 102 may be AC-AC converters that receive AC power and convert the received AC power to another AC power. In one or more embodiments the PCUs 102 generate single-phase AC power; alternatively, the PCUs 102 may generate two or three phases of AC power.

In one or more embodiments the PCUs 102 convert DC power generated by the power modules 104 into AC power (i.e., the PCUs 102 are DC-AC inverters) and couple the generated AC power to the commercial AC power grid via the load center 108. The power generated by the system 100 may be distributed for use, for example to one or more appliances, and/or the generated energy may be stored for later use, for example using batteries, heated water, hydro pumping, H₂O-to-hydrogen conversion, or the like.

The controller 110 is capable of communicating with the PCUs 102 for receiving data from the PCUs 102 (such as alarms, messages, operating data and the like) and transmitting data to the PCUs 102 (such as command and control signals for operably controlling the PCUs 102). The controller 110 may be further communicatively coupled, by wireless and/or wired techniques, to a remote system (such as a master controller). In some embodiments the controller 110 may be a gateway for receiving information from (e.g., command and control information pertaining to the PCUs 102) and/or sending information to (e.g., performance data pertaining to the PCUs 102) another device, such as a remote master controller (not shown), for example via a communications network such as the Internet.

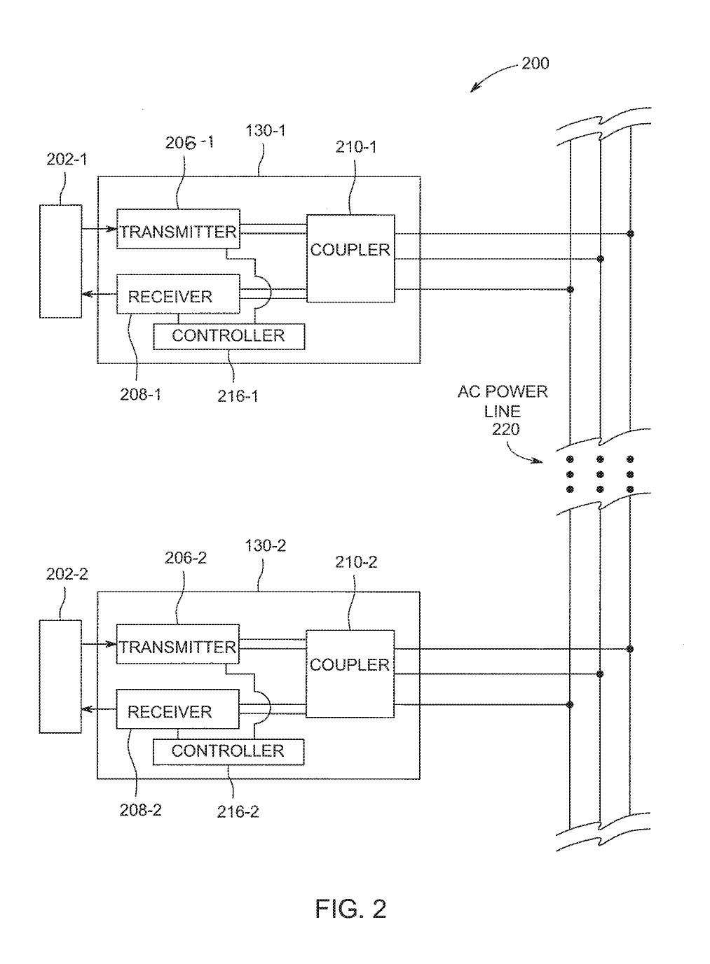

Each of the PLCTs 130 comprises a transmitter (described below with respect to FIG. 2) and a receiver (described below with respect to FIG. 2) for transmitting and receiving data, respectively, via the AC power line 106. Each of the PLCTs 130 may additionally comprise one or more PLC controllers (described below with respect to FIG. 2).

The PCUs 102 and the controller 110 communicate using PLC over the AC power line 106 via the PLCTs 130. In accordance with one or more embodiments of the present invention, the PLCTs 130 employ the channel estimation and compensation for three-phase PLC as described below. After applying the channel compensation, any imbalance of the channel can be corrected, resulting in a substantially ideal channel. With the channel estimation method described herein, performance loss due to any imbalance on the three-phase channel; i.e., the transmitter power can be lowered to achieve the same system performance.

FIG. 2 is a block diagram of a system 200 for power line communications in accordance with one or more embodiments of the present invention. The system 200 comprises a device 202-1 coupled to a power line communications transceiver (PLCT) 130-1, which is further coupled to an AC power line 220 (“power line 220”). The system 200 further comprises a device 202-2 coupled to a PLCT 130-2, which is further coupled to the power line 220. In some embodiments, one or both of the PLCTs 130-1 and 130-2 may be coupled to the power line 220 via a junction box (not shown).

The devices 202-1 and 202-2, collectively referred to as devices 102, are devices requiring communications bandwidth for transmitting and/or receiving data, such as a home computer, peripheral device, power converters, and the like, and are capable of communicating with one another over the power line 120 via the PLCTs 130-1 and 130-2, respectively. One particular embodiment that uses the inventive system is described above with respect to FIG. 1.

The PLCT 130-1 comprises a transmitter 206-1 and a receiver 208-1, each coupled to the device 202-1, and a coupler 210-1 that couples both the transmitter 206-1 and the receiver 208-1 to the power line 220. When the PLCT 130-1 is operating in a “transmit mode”, the transmitter 206-1 is capable of transmitting data to the device 202-2 via the power line 220.

The receiver 208-1 is capable of receiving data from the device 202-2 via the power line 220. The PLCT 130-1 may be able to simultaneously receive and transmit data; however, the transmitter 106-1 may generally blind the receiver 208-1 while active. A PLCT controller 216-1 is coupled to the PLCT transmitter 206-1 and the receiver 208-1 and provides various control for the PLCT 130-1. In some other embodiments, the PLCT controller 216 may be separate from the PLCT 130-1 rather than a component of the PLCT 130-1.

Analogous to the PLCT 130-1, the PLCT 130-2 comprises a transmitter 206-2, a receiver 208-2, and a coupler 210-2. The transmitter 206-2 and receiver 208-2 are coupled to the device 202-2 as well as the coupler 210-2, and the coupler 210-2 is further coupled to the power line 220. A PLCT controller 216-2 is coupled to the transmitter 206-2 and the receiver 208-2 and provides various control for the PLCT 130-2. In some embodiments, the PLCT controller 216-2 may be separate from the PLCT 130-2 rather than a component of the PLCT 130-2. The PLCT 130-2 transmits and receives data analogous to the PLCT 130-1.

The PLCT controllers 216-1 and 216-2 (collectively referred to as PLCT controllers 216) may be comprised of hardware, software, or a combination thereof, and may in certain embodiments comprise a central processing unit (CPU) coupled to each of support circuits and a memory. The PLCT controllers 216 may be implemented using a general purpose computer that, when executing particular software, becomes a specific purpose computer for performing various embodiments of the present invention.

In those embodiments where the PLCT controllers 216 include a CPU, the CPU may comprise one or more conventionally available microprocessors, microcontrollers and the like, which are capable of performing the processing described herein; e.g., the CPU may be a microcontroller comprising internal memory for storing controller firmware that, when executed, provides the functionality described herein. In certain embodiments, the CPU may include one or more application specific integrated circuits (ASICs). The support circuits coupled to the CPU are well known circuits used to promote functionality of the CPU. Such circuits include, but are not limited to, a cache, power supplies, clock circuits, buses, network cards, input/output (I/O) circuits, and the like. The memory coupled to the CPU may comprise random access memory, read only memory, removable disk memory, flash memory, and various combinations of these types of memory. The memory is sometimes referred to as main memory and may, in part, be used as cache memory or buffer memory. The memory generally stores the operating system (OS) of the PLC controller, which may be one of a number of commercially available OSs such as, but not limited to, Linux, Real-Time Operating System (RTOS), and the like. The memory generally stores various forms of application software, such as a three-phase PLC channel estimation and compensation module, and one or more databases for performing one or more functions pertaining to the invention described herein.

In some alternative embodiments, the PLCTs 130 are only used for transmitting information via the power line 120; in some of such embodiments, the receivers 208-1 and 208-2 are not present within the PLCTs 130-1 and 130-2.

In accordance with one or more embodiments of the present invention, a packet-by-packet channel estimation is performed by the PLCTs 130 to estimate the three-phase PLC channel within the preamble. The channel estimation performed allows the system performance to be predicted, for example, to provide guidance for three-phase mode selection (e.g., one stream mode or two stream mode). Further, channel compensation can be applied based on the estimated three-phase PLC channel in order to obtain transmission via an ideal-like channel.

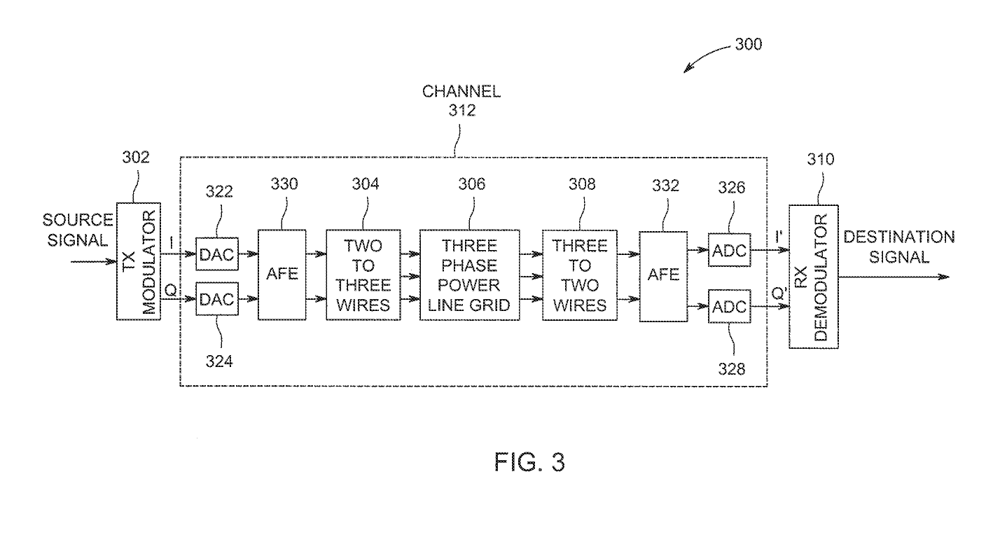

FIG. 3 is a logical block diagram of a three-phase PLC system 300 in accordance with one or more embodiments of the present invention. As depicted in the PLC system 300, a source signal is input into a modulator 302 which modulates the source signal to generate two independent in-phase (I) and quadrature (Q) signal streams. The I, Q streams may be generated using modulation techniques such as Quadrature Phase Shift Keying (QPSK), Quadrature Amplitude Modulation (QAM), or Frequency Shift Keying (FSK). In one or more of those embodiments where FSK in employed, a Hilbert filter may be used to obtain the 90 degree phase difference of the Q stream.

In order to obtain the three-phase power line transmission balance, the sum of the three-phase power line voltage or current must be zero. The two independent I, Q streams are input to digital-to-analog converters (DACs) 322 and 324, respectively, and the DAC outputs are input to an analog front end (AFE) module 330 (e.g., the DACs 322 and 324 and the AFE module 330 are components of the transmitter 206-1). The two output signals from the AFE module 330 are converted to three phases by a two-to-three-wire module 304 on the transmit side (e.g., the coupler 210-1) and coupled to a three-phase grid 306 (e.g., the AC power line 220).

The three output phases from the three-phase grid 306 are coupled to a three-to-two-wire module 308 on the receiver side (e.g., the coupler 210-2), which converts the three phase signals back to two signals that are input to an AFE module 332, with the two output signals from the AFE module 332 input to analog-to-digital converters (ADCs) 326 and 328. The outputs from the ADCs 326 and 328 are the two independent received signal streams I′, Q′, which are then demodulated by a demodulator 310 (e.g., a demodulator of the receiver 208-2) to obtain a recovered data signal. In one or more embodiments, the source signal is generated by the device 202-1, the modulator 302, DACs 322 and 324, and AFE module 330 are components of the transmitter 206-1; the two-to-three wire module 304 is a component of the coupler 210-1; the grid 306 is the AC power line 220; the three-to-two wire module 308 is a component of the coupler 210-2; the AFE module 332, DACs 326 and 328, and the demodulator 310 are components of the receiver 208-2; and the recovered data signal is coupled to the device 202-1.

During the process of converting the I, Q streams to three phases for transmission over the three-phase power line grid 306, and converting the received three phase signals to the I′, Q′ streams at the receive side, the received signals I′, and Q′ may be a distorted version of transmitted I, Q. By using transmitted I, Q signals that are known at the receiver, such as preamble, reference or pilot signals, a mathematic matrix operation can be used to recover the I, Q signals from the received signal I′, Q′ as described below. The determined matrix provides an estimation of the transmission channel via the module 304/grid 306/module 308, which together may be referred to as a channel 312. Once the channel estimation matrix is determined from the reference signals, it can be applied to the received I′, Q′ signals as described below.

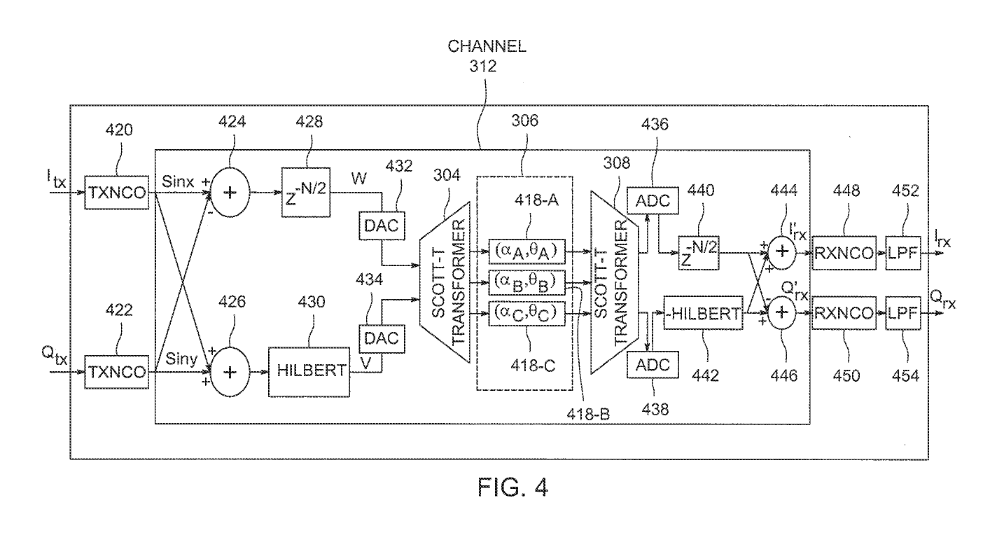

FIG. 4 is a logical block diagram of a three-phase channel 312 according to one or more embodiments where precoding is used (i.e., a precoded mode). Embodiments of the invention described with respect to FIG. 4 may be implemented hardware, software, or some combination thereof.

In addition to the modules 304 and 308 (which, in one or more embodiments are Scott-T transformers) and the grid 306, the channel 312 comprises adders 424, 426, 444 and 446; filters 428, 430 (a Hilbert filter), 440, and 442 (an inverse Hilbert filter); digital to analog converters (DACs) 432 and 434; and analog to digital converters (ADCs) 436 and 438. The adders 424 and 426, filters 428 and 430, DACs 432 and 434, and two-to-three wire module 304 are part of the transmitter 206; the three-to-two wire module 308, ADCs 436 and 438, filters 440 and 442, and adders 444 and 446 are part of the receiver 208.

Precoding is a technique which exploits transmit diversity by weighting information streams, i.e. the transmitter sends the coded information to the receiver and reduces the corruption effects of the communication channel.

As depicted in FIG. 4, the generated Iₜₓ, and Qₜₓ streams are input to the NCOs 420 and 422, respectively, to generate the respective signals sin(x) and sin(y) (where x and y are the signals after the up-conversion, i.e., x=2πf_{c}t+Σ₌₀^{t}Iₜₓ(i) and y=2πf_{c}t+Σ₌₀^{t}Qₜₓ(i)) that are input to the channel 312 as shown in FIG. 4. The signals output from the channel 312, I′ᵣₓ, Q′ᵣₓ, are input to the NCOs 448 and 450, respectively, and the recovered signals Iᵣₓ and Qᵣₓ are output from the LPFs 452.

The channel 312 shown in FIG. 4 can be described mathematically by following equation:

$$[ \begin{matrix}{I}^{′} \\ {Q}^{′}\end{matrix} ] = [ \begin{matrix}1 & 1 \\ 1 & - 1\end{matrix} ] [ \begin{matrix}1 & 0 \\ 0 & - \tilde{h}\end{matrix} ] \underbrace{[ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{α}_{A} & 0 & 0 \\ 0 & {α}_{B} & 0 \\ 0 & 0 & {α}_{C}\end{matrix} ]}_{[ \begin{matrix}{α}_{A} & - \frac{1}{2} {α}_{B} & - \frac{1}{2} {α}_{C} \\ 0 & \frac{\sqrt{3}}{2} {α}_{B} & - \frac{\sqrt{3}}{2} {α}_{C}\end{matrix} ]} \times [ \begin{matrix}cos {θ}_{A} & sin {θ}_{A} \\ cos ( 120 + {θ}_{B} ) & sin ( 120 + {θ}_{B} ) \\ cos ( - 120 + {θ}_{C} ) & sin ( - 120 + {θ}_{C} )\end{matrix} ] \underbrace{[ \begin{matrix}1 & 0 \\ 0 & \tilde{h}\end{matrix} ] [ \begin{matrix}1 & 1 \\ 1 & - 1\end{matrix} ] [ \begin{matrix}sin x \\ sin y\end{matrix} ]}_{[ \begin{matrix}sin x + sin y \\ - cos x + cos y\end{matrix} ]} \qquad ( 1 )$$

Where:

$$[ \begin{matrix}1 & 1 \\ 1 & - 1\end{matrix} ]$$

is the precoding matrix,

$$[ \begin{matrix}1 & 0 \\ 0 & h\end{matrix} ]$$

is the Hilbert Transform matrix.

$$[ \begin{matrix}1 & - \frac{1}{2} & - \frac{1}{2} \\ 0 & \frac{\sqrt{3}}{2} & - \frac{\sqrt{3}}{2}\end{matrix} ]$$

is the Scott-T transform Matrix,

$$[ \begin{matrix}{α}_{A} & 0 & 0 \\ 0 & {α}_{B} & 0 \\ 0 & 0 & {α}_{C}\end{matrix} ]$$

describes the amplitude imbalance of the three phase grid 306,

$$[ \begin{matrix}cos {θ}_{A} & sin {θ}_{A} \\ cos ( 120 + {θ}_{B} ) & sin ( 120 + {θ}_{B} ) \\ cos ( - 120 + {θ}_{C} ) & sin ( 120 + {θ}_{C} )\end{matrix} ]$$

describes the phase imbalance of the three phase grid 306 and the three-to-two wire module 308 at the receiver. The mis-wire of three phase could also be modelled by the phase imbalance.

$$[ \begin{matrix}1 & 0 \\ 0 & - h\end{matrix} ]$$

is the inverse Hilbert Transform matrix at the receiver, and

$$[ \begin{matrix}1 & 1 \\ 1 & - 1\end{matrix} ]$$

is the inverse pre-coding matrix.

The channel model (i.e., the phase and amplitude imbalance model) shown in Equation (1) can be rewritten as an equivalent channel model comprising the parameters A, B, C, and D as shown in Equation (2):

$$[ \begin{matrix}{I}^{′} \\ {Q}^{′}\end{matrix} ] = [ \begin{matrix}A & B & C & - D \\ C & D & A & - B\end{matrix} ] [ \begin{matrix}sin x \\ cos x \\ sin y \\ cos y\end{matrix} ] \qquad ( 2 )$$

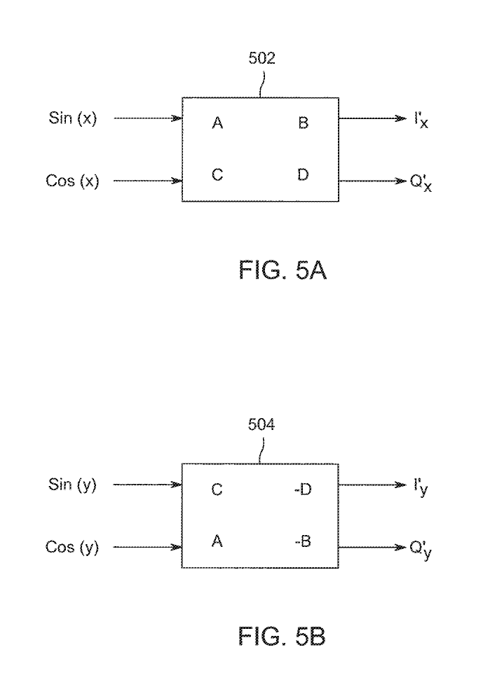

In order to efficiently estimate the channel parameters A, B, C, and D, a decomposition of Equation (2) into two parts is performed as shown in Equation (3):

$$[ \begin{matrix}{I}^{′} \\ {Q}^{′}\end{matrix} ] = [ \begin{matrix}A & B \\ C & D\end{matrix} ] [ \begin{matrix}sin x \\ cos x\end{matrix} ] + [ \begin{matrix}C & - D \\ A & - B\end{matrix} ] [ \begin{matrix}sin y \\ cos y\end{matrix} ] \qquad ( 3 )$$

where the matrix A B C D in Equation (3) is represented by the sub-channel model 502, depicted in FIG. 5A as having input signals sin(x) and cos(x) and output signals I_{X} and Q_{X} (i.e., the sub-channel model when {sin x,0} is transmitted), and the matrix C −D A −B in Equation (3) is represented by the sub-channel model 504, depicted in FIG. 5B as having input signals sin(y) and cos(y) and output signals I_{Y} and Q_{Y} (i.e., the sub-channel model when {0,sin y} is transmitted).

In order to perform the channel estimation, the transmit signal is designed as follows. First, with respect to the channel model 502, the I-path signal sin(x) is transmitted and nothing is transmitted on the y-path (i.e., no Q path is transmitted). By thus using the I, Q channel to send {sin x, 0}, the resulting received signals Iₓ, Qₓ are shown as Equations (4) and (5):

I′ₓ=A sin(2πf_{c}t+θₓ)+B cos(2πf_{c}t+θₓ) (4)

Q′ₓ=C sin(2πf_{c}t+θₓ)+D cos(2πf_{c}t+θₓ) (5)

Based on the sin(x) transmission and received signal, the corresponding cos(x) information can be determined through the Hilbert transform in the transmitter.

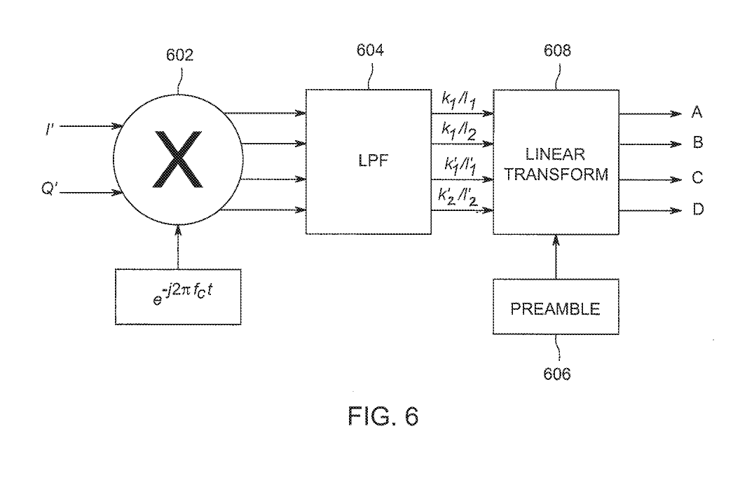

FIG. 6 is a block diagram depicting a complex down-conversion, low pass filtering, and linear transformation to obtain the channel matrix parameters A, B, C and D in accordance with one or more embodiments of the present invention. As shown in FIG. 6, the signals I′ and Q′, along with e^{-j2πf}^{_{c}}^{t}, are input to a multiplier 602. The four output signals from the multiplier 602 are input to a low pass filter (LPF) 606. The four output signals from the LPF 604, along with the preamble 606, are input to a linear transform 608 to obtain the parameters A, B, C and D at the output of the linear transform 608. The multiplier 602, LPF 604, and linear transform 608 are part of the receiver 208. Embodiments of the invention described with respect to FIG. 6 may be implemented hardware, software, or some combination thereof.

After mixing e^{-j2πf}^{_{c}}^{t} (i.e., a complex down-conversion) and low pass filtering (LPF) at the receiver, the parameters k₁, k₂, k′₁, and k′₂ can be obtained from transmitting the data {sin x, 0}. As is known in Equations (5.1) and (5.2):

$$\begin{matrix}{I}_{x}^{′} cos ( {ω}_{c} t ) = A sin ( 2 π {f}_{c} t + {θ}_{x} ) cos ( 2 π {f}_{c} t ) + B cos ( 2 π {f}_{c} t + {θ}_{x} ) cos ( 2 π {f}_{c} t ) \\ = \frac{1}{2} [ A sin ( 4 π {f}_{c} t + {θ}_{x} ) + A sin ( {θ}_{x} ) ] + \frac{1}{2} [ B cos ( {θ}_{x} ) + \\ B cos ( 4 π {f}_{c} t + {θ}_{x} ) ]\end{matrix} \qquad \begin{matrix}( 5.1 ) \\ ( 5.2 )\end{matrix}$$

Following the low pass filtering by the LPF 604, the second harmonic items vanish and the parameters, the constant ½ will be dropped in the following equation. k₁, k₂, k′₁, k′₂ are obtained as shown in Equations (6)-(9):

k₁=LPF(I′ₓ cos(ω_{c}t))=A sin θₓ+B cos θₓ (6)

k₂=LPF(−I′ₓ sin(ω_{c}t))=−A cos θₓ+B sin θₓ (7)

k′₁=LPF(Q′ₓ cos(ω_{c}t))=C sin θₓ+D cos θₓ (8)

k′₂=LPF(−Q′ₓ sin(ω_{c}t))=−C cos θₓ+D sin θₓ (9)

By multiplying sin θₓ and cos θₓ on k₁, k₂, k′₁, k′₂, the channel parameters A, B, C and D are obtained as shown in Equations (10)-(13):

A=(k₁)sin θₓ−(k₂)cos θₓ (10)

B=(k₁)cos θₓ+(k₂)sin θₓ (11)

D=(k′₂)sin θₓ+(k′₁)cos θₓ (12)

C=(k′₁)sin θₓ−(k′₂)cos θₓ (13)

Next, with respect to the channel model 504, the Q-path signal sin(y) is transmitted and nothing is transmitted on the x-path (i.e., no I path is transmitted). By thus using the I, Q channel to send {0, sin y}, the resulting received signals I_{Y}, Q_{Y} are shown as Equations (14) and (15):

I′_{y}=C sin(2πf_{c}t+θ_{y})−D cos(2πf_{c}t+θ_{y}) (14)

Q′_{y}=A sin(2πf_{c}t+θ_{y})−B cos(2πf_{c}t+θ_{y}) (15)

After mixing e^{-j2πf}^{_{c}}^{t} and low pass filtering (LPF) at the receiver as previously described with respect to FIG. 6, the parameters l₁, l₂, l′₁, and l′₂ can be obtained at the output of the LPF 604 as shown in Equations (16)-(19):

l₁=LPF(I′_{y} cos(ω_{c}t))=C sin θ_{y}−D cos θ_{y} (16)

l₂=LPF(−I′_{y} sin(ω_{c}t))=−C cos θ_{y}+D sin θ_{y} (17)

l′₁=LPF(Q′_{y} cos(ω_{c}t))=A sin θ_{y}−B cos θ_{y} (18)

l′₂=LPF(−Q′_{y} sin(ω_{c}t))=−A cos θ_{y}−B sin θ_{y} (19)

Since the sin(x) and sin(y) are part of the overall preamble, setting sin(x)=sin(y)=sin(θn) and dropping a constant ½ from the down-conversion and low pass filtering equations, Equations (20)-(23) can be obtained:

A sin θₙ=k₁+l′₁ (20)

B cos θₙ=k₁−l′₁ (21)

A cos θₙ=−(k₂+l′₂) (22)

B sin θₙ=k₂−l′₂ (23)

The A and B estimations can be obtained using statistics from {sin(x), 0} (i.e., transmitting on the I path) and {0, sin(x)}, where sin(y)=sin(x), (i.e., transmitting on the Q path), and the C and D estimations can be obtained using statistics from {sin(x), 0} and {0, sin(x)}. Memory (e.g., within the controller 216) is required to save the samples from {sin(x), 0}; i.e., since x includes the sum of all previous preamble symbols, these values are needed to do the channel estimation.

The parameters A, B, C and D for the channel estimation matrix can be obtained as shown in Equations (24)-(27):

A=(k₁+l′₁)sin θₙ−(k₂+l′₂)cos θₙ (24)

B=(k₁−l′₁)sin cos θₙ+(k₂−l′₂)sin θₙ (25)

C=(l₁+k′₁)sin θₙ−(l₂+k′₂)cos θₙ (26)

D=(k′₁−l₁)cos θₙ+(k′₂−l₂)cos θₙ (27)

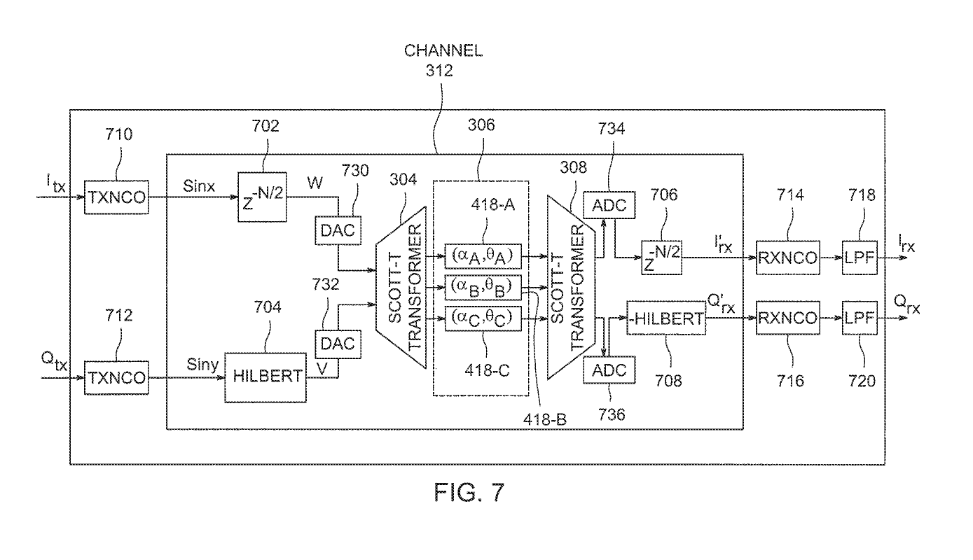

FIG. 7 is a logical block diagram of a three-phase channel 312 according to one or more embodiments where precoding is not used (i.e., a direct mode for dual stream). The embodiment depicted in FIG. 7 and described herein is also backwards-compatible for use with a two-phase system. The channel estimation technique is an efficient, low-complexity blind estimation technique without the use of a divider; additionally, the estimation works well even in low noise levels. Embodiments of the invention described with respect to FIG. 7 may be implemented hardware, software, or some combination thereof.

As shown in FIG. 7, the two parallel streams Iₜₓ (i.e., the transmitted signal on the I path) and Qₜₓ (i.e., the transmitted signal on the Q path) are input to transmitter numerically controlled oscillators (NCOs) 710 and 712, respectively. The outputs from the NCOs 710 and 712, sin x and sin y, respectively, are input to the filter 702 and the Hilbert filter 704, respectively, of the channel 312. The output signals from the filter 702 and the Hilbert filter 704, w and v respectively, are input via DACs 730 and 732 to the two-to-three wire module 304. The NCOs 710 and 712, filters 702 and 704, DACs 730 and 732, and two-to-three wire module 304 are part of the transmitter 206.

The three output phases from the module 304 are input into the different phase lines 418-A, 418-B, and 418-C of the grid 306, where the amplitude and phase lines 418-A, 418-B, and 418-C imbalances are represented by parameters (αA, θA), (αB, θB), and (αC, θC), respectively.

The outputs from the phase lines 418-A, 418-B, and 418-C are inputs to the three-to-two wire module 308, and the two outputs from module 308 are input via ADCs 734 and 736 to the filter 706 and the inverse Hilbert filter 708 to generate the received signals Iᵣₓ′ and Qᵣₓ′, respectively, output from the channel 312. The signals Iᵣₓ′ and Qᵣₓ′ are respectively input to receiver NCOs 714 and 716, and their respective outputs are low pass filtered by LPFs 718 and 720 to generate the recovered Iᵣₓ and Qᵣₓ signals. The three-to-two wire module 308, ADCs 734 and 736, filters 706 and 708, NCOs 714 and 716, and LPFs 718 and 720 are part of the receiver 208.

The channel 312 shown in FIG. 7 can be described mathematically by following Equation (28):

$$[ \begin{matrix}{I}^{′} \\ {Q}^{′}\end{matrix} ] = [ \begin{matrix}1 & 0 \\ 0 & - \tilde{h}\end{matrix} ] \underbrace{[ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{α}_{A} & 0 & 0 \\ 0 & {α}_{B} & 0 \\ 0 & 0 & {α}_{C}\end{matrix} ]}_{[ \begin{matrix}{α}_{A} & - \frac{1}{2} {α}_{B} & - \frac{1}{2} {α}_{C} \\ 0 & \frac{\sqrt{3}}{2} {α}_{B} & - \frac{\sqrt{3}}{2} {α}_{C}\end{matrix} ]} \times [ \begin{matrix}cos {θ}_{A} & sin {θ}_{A} \\ cos ( 120 + {θ}_{B} ) & sin ( 120 + {θ}_{B} ) \\ cos ( - 120 + {θ}_{C} ) & sin ( - 120 + {θ}_{C} )\end{matrix} ] \underbrace{[ \begin{matrix}1 & 0 \\ 0 & \tilde{h}\end{matrix} ] [ \begin{matrix}sin x \\ sin y\end{matrix} ]}_{[ \begin{matrix}sin x + sin y \\ - cos x + cos y\end{matrix} ]} \qquad ( 28 )$$

Where:

$$[ \begin{matrix}1 & 0 \\ 0 & - h\end{matrix} ]$$

is the Hilbert Transform matrix.

$$[ \begin{matrix}1 & - \frac{1}{2} & - \frac{1}{2} \\ 0 & \frac{\sqrt{3}}{2} & - \frac{\sqrt{3}}{2}\end{matrix} ]$$

is the Scott-T transform Matrix,

$$[ \begin{matrix}{α}_{A} & 0 & 0 \\ 0 & {α}_{B} & 0 \\ 0 & 0 & {α}_{C}\end{matrix} ]$$

describes the amplitude imbalance of the three phase grid 306,

$$[ \begin{matrix}cos {θ}_{A} & sin {θ}_{A} \\ cos ( 120 + {θ}_{B} ) & sin ( 120 + {θ}_{B} ) \\ cos ( - 120 + {θ}_{C} ) & sin ( 120 + {θ}_{C} )\end{matrix} ]$$

describes the phase imbalance of the three phase grid 306 and the three-to-two wire module 308 at the receiver, and

$$[ \begin{matrix}1 & 0 \\ 0 & h\end{matrix} ]$$

is the inverse Hilbert Transform matrix at the receiver, and

The channel model (i.e., the phase and amplitude imbalance model) shown in Equation (28) can be rewritten as an equivalent channel model comprising the parameters A, B, C, and D as shown in Equation (29):

$$[ \begin{matrix}{I}^{′} \\ {Q}^{′}\end{matrix} ] = [ \begin{matrix}A & 0 & 0 & B \\ 0 & C & D & 0\end{matrix} ] [ \begin{matrix}sin x \\ cos x \\ sin y \\ cos y\end{matrix} ] \qquad ( 29 )$$

Analogous to the technique described with respect to Equations (3)-(19), a decomposition into two parts can be performed, the sin x signal (i.e., the x-path signal) can be transmitted while nothing is transmitted on the y-path to obtain the parameters k₁, k₂, k₁′, and k₂′ (which are functions of the parameters A and C), and the sin y signal (i.e., the y-path signal) can be transmitted while nothing is transmitted on the x-path to obtain the parameters l₁, l₂, l₁′, and l₂′ (which are functions of the parameters B and D). The resulting statistical parameters k₁, k₂, k₂′, l₁, l₂, l₁′, and l₂′ are shown in Equations (30)-(37):

k₁=LPF(Iₓ cos(ω_{c}t))=A sin θₓ (30)

k₂=LPF(−Iₓ sin(ω_{c}t))=−A cos θₓ (31)

k′₁=LPF(Qₓ cos(ω_{c}t))=C cos θₓ (32)

k′₂=LPF(−Qₓ sin(ω_{c}t))=C sin θₓ (33)

l₁=LPF(I_{y} cos(ω_{c}t))=B cos θ_{y} (34)

l₂=LPF(−I_{y} sin(ω_{c}t))=B sin θ_{y} (35)

l′₁=LPF(Q_{y} cos(ω_{c}t))=D sin θ_{y} (36)

l′₂=LPF(−Q_{y} sin(ω_{c}t))=−D cos θ_{y} (37)

By assigning sin θₙ=sin θₓ=sin θ_{y}, the channel matrix estimation can be obtained as in equations (38)-(41):

A=(k₁)sin θₙ−(k₂)cos θₙ (38)

B=(l₁)cos θₙ+(l₂)sin θₙ (39)

C=(k′₂)sin θₙ+(k′₁)cos θₙ (40)

D=(l₁′)sin θₙ−(l′₂)cos θₙ (41)

The A and C parameters will be estimated from the transmission {sin(x), 0} (i.e., transmitting on the I path), and the B and D parameters will be estimated from the transmission {0, sin(x)}, where sin(y)=sin(x), (i.e., transmitting on the Q path). No memory is required for estimating the A, B, C and D parameters for the embodiment described with respect to FIG. 7; i.e., the parameter A,B,C,D could be estimated on symbol-by-symbol basis, not needing to store the samples k₁,k₂,l₁,l₂,k′₁,k′₂,l′₁,l′₂.

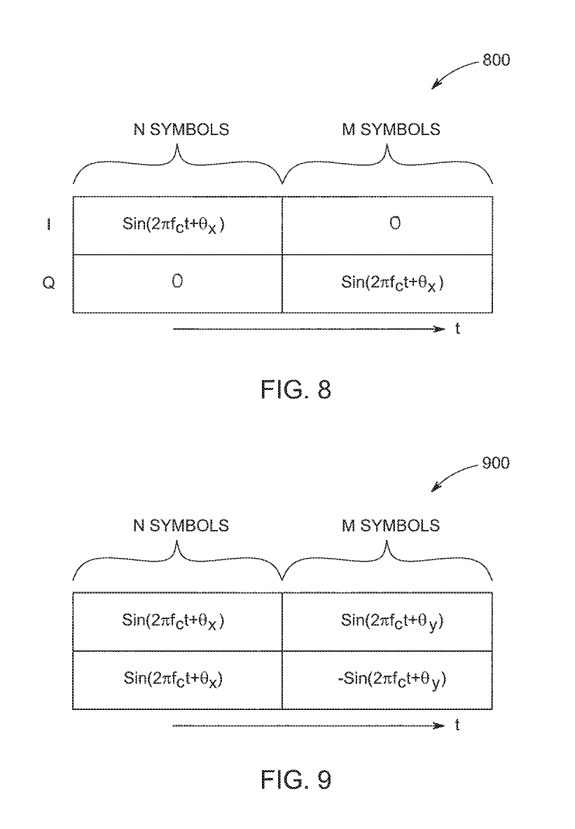

FIG. 8 depicts the I, Q preamble structures 800 for packet detection and channel estimation in accordance with one or more embodiments of the present invention. FIG. 9 depicts the I, Q preamble structures 900 for packet detection and channel estimation in accordance with one or more other embodiments of the present invention. In some embodiments, it is desirable to not send null signals over the preamble, and the channel parameters {A,B,C,D} can be estimated from the preamble data sin θₓ and sin θ_{y} as shown in FIG. 9 rather than the preamble pattern shown in FIG. 8.

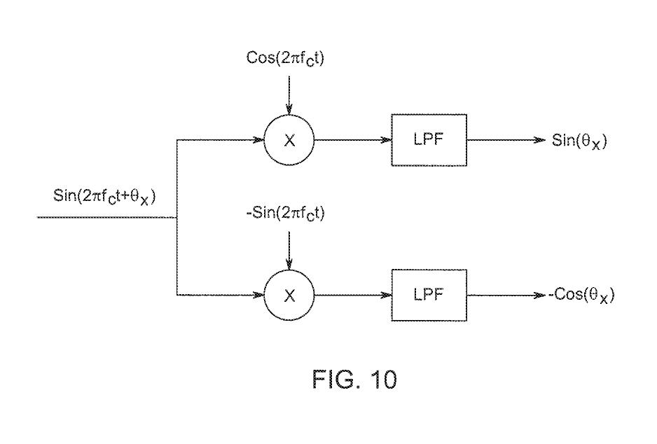

FIG. 10 is a block diagram depicting down-conversion in accordance with one or more embodiments of the present invention. Embodiments of the invention described with respect to FIG. 10 may be implemented hardware, software, or some combination thereof.

Once the channel characteristic parameters {A,B,C,D} are estimated from the preamble, the header and payload signals can be compensated to recover the original transmitted signals. As depicted in FIG. 10, the down-conversion or mixing is implemented by multiplying e^{-j2πf}^{_{c}}^{t}, so that the LPF output is sin θₓ and −cos θₓ.

The uncompensated signal output from LPF is

II=LPF(I cos(2πf_{c}t))=A sin θₓ+B cos θₓ+C sin θ_{y}−D cos θ_{y} (42)

IQ=LPF(−I sin(2πf_{c}t))=−B sin θₓ+A cos θₓ+D sin θ_{y}+C cos θ_{y} (43)

QI=LPF(Q cos(2πf_{c}t))=C sin θₓ+D cos θₓ+A sin θ_{y}−B cos θ_{y} (44)

QQ=LPF(−Q sin(2πf_{c}t))=−D sin θₓ+C cos θₓ+B sin θ_{y}+A cos θ_{y} (45)

This can be expressed in the matrix form as shown in Equation (46):

$$[ \begin{matrix}II \\ IQ \\ QI \\ QQ\end{matrix} ] = [ \begin{matrix}A & B & C & - D \\ - B & A & D & C \\ C & D & A & - B \\ - D & C & B & A\end{matrix} ] [ \begin{matrix}sin {θ}_{x} \\ cos {θ}_{x} \\ sin {θ}_{y} \\ cos {θ}_{y}\end{matrix} ] \qquad ( 46 )$$

which can be decoupled into two parts as shown in Equations (47) and (48)

$$\begin{matrix}[ \begin{matrix}II \\ QI\end{matrix} ] = [ \begin{matrix}A & B & C & - D \\ C & D & A & - B\end{matrix} ] [ \begin{matrix}sin {θ}_{x} \\ cos {θ}_{x} \\ sin {θ}_{y} \\ cos {θ}_{y}\end{matrix} ] & ( 47 ) \\ [ \begin{matrix}IQ \\ QQ\end{matrix} ] = [ \begin{matrix}- B & A & C & - D \\ - D & C & B & A\end{matrix} ] [ \begin{matrix}sin {θ}_{x} \\ cos {θ}_{x} \\ sin {θ}_{y} \\ cos {θ}_{y}\end{matrix} ] & ( 48 )\end{matrix}$$

From Equation (47), sin θₓ and sin θ_{y} can be recovered, and from Equation (48), cos θₓ and cos θ_{y} can be recovered. Since

$$[ \begin{matrix}II \\ QI\end{matrix} ] = [ \begin{matrix}A - B j & C + D j \\ C - D j & A + B j\end{matrix} ] [ \begin{matrix}sin {θ}_{x} \\ sin {θ}_{y}\end{matrix} ] \qquad ( 49 )$$

then,

$$[ \begin{matrix}sin {θ}_{x} \\ sin {θ}_{y}\end{matrix} ]$$

can be recovered as shown in Equation (50):

$$[ \begin{matrix}sin {θ}_{x} \\ sin {θ}_{y}\end{matrix} ] = \frac{1}{( {A}^{2} + {B}^{2} ) - ( {C}^{2} + {D}^{2} )} [ \begin{matrix}A + B j & - C - D j \\ - C + D j & A - B j\end{matrix} ] [ \begin{matrix}II \\ QI\end{matrix} ] \qquad ( 50 )$$

Note that II and QI are real signal output from the LPF. The scaling factor

$$\frac{1}{( {A}^{2} + {B}^{2} ) - ( {C}^{2} + {D}^{2} )}$$

can be ignored.

Given Equations (51.1) and (51.2):

(j)II=IQ (51.1)

(j)QI=−QQ (51.2)

an additional Hilbert filter is not needed to obtain (j)II and (j)QI. Then, the channel can be compensated as shown in Equations (52.1) and (52.2):

sin θₓ=(A+Bj)II+(−C−Dj)QI=A*II−B*IQ−C*QI+D*QQ (52.1)

sin θ_{y}=(−C+Dj)II+(A−Bj)QI=−C*II−D*IQ+A*QI+B*QQ (52.2)

Similar, given Equation (53):

$$[ \begin{matrix}IQ \\ QQ\end{matrix} ] = [ \begin{matrix}A - B j & C + D j \\ C - D j & A + B j\end{matrix} ] [ \begin{matrix}cos {θ}_{x} \\ cos {θ}_{y}\end{matrix} ] \qquad ( 53 )$$

$$[ \begin{matrix}cos {θ}_{x} \\ cos {θ}_{y}\end{matrix} ]$$

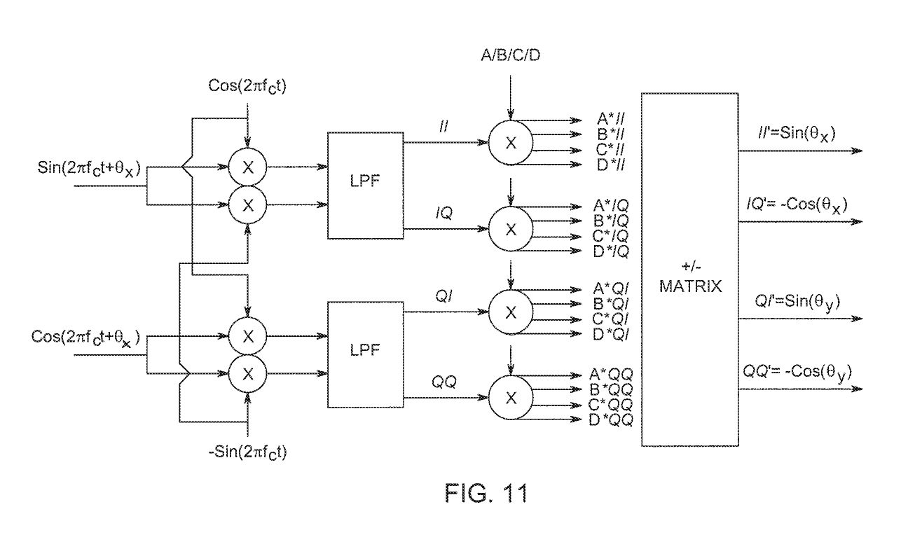

can be recovered as shown in Equations (54)-(56):

$$\begin{matrix}[ \begin{matrix}cos {θ}_{x} \\ cos {θ}_{y}\end{matrix} ] = \frac{1}{( {A}^{2} + {B}^{2} ) - ( {C}^{2} + {D}^{2} )} [ \begin{matrix}A + B j & - C - D j \\ - C + D j & A - B j\end{matrix} ] [ \begin{matrix}IQ \\ QQ\end{matrix} ] & ( 54 ) \\ cos {θ}_{x} = A * IQ + B * II - C * QQ - D * QI & ( 55 ) \\ cos {θ}_{y} = - C * ID + D * II + A * QQ - B * QI & ( 56 )\end{matrix}$$

where (j)IQ=II and (j)QQ=QI. The resulting channel compensation for the pre-coded dual stream is depicted in FIG. 11, where the signals sin θₓ, −cos θₓ, sin θ_{y}, and −cos θ_{y} are the decoded received information. Embodiments of the invention described with respect to FIG. 11 may be implemented hardware, software, or some combination thereof.

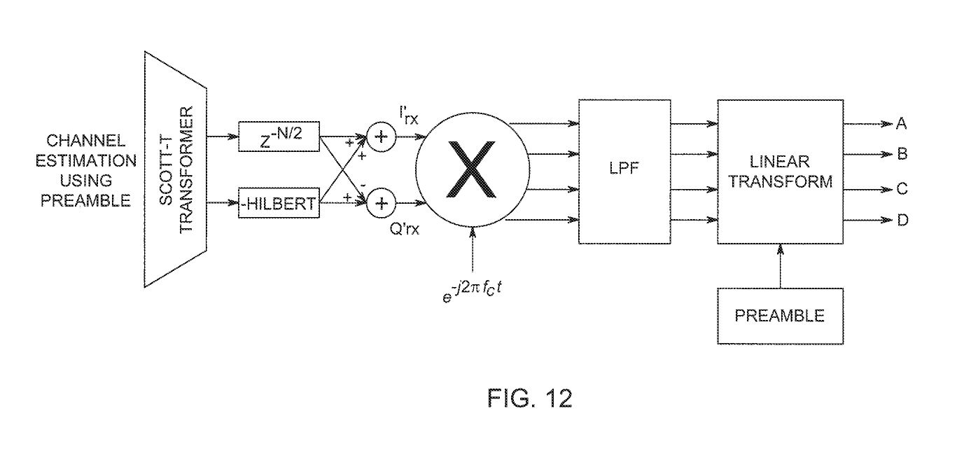

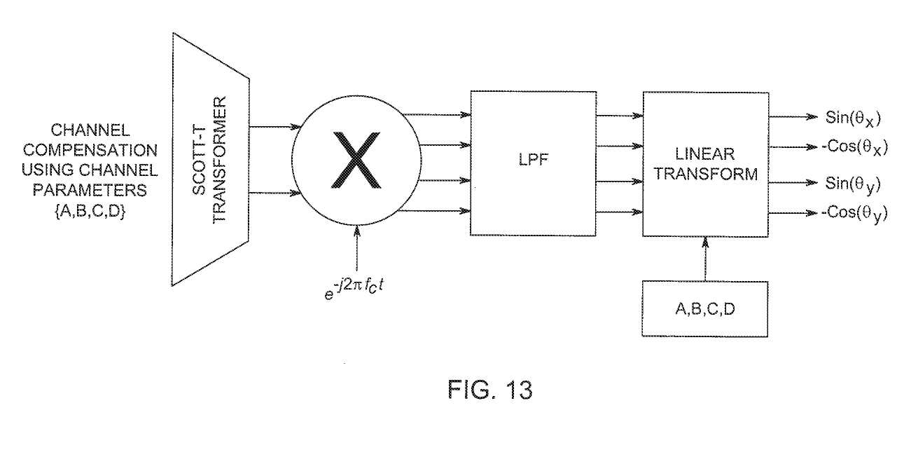

FIGS. 12 and 13 summarize the two major steps to mitigate the impairments introduced by the channel amplitude and phase imbalances. It should be mentioned that the Hilbert Transform is not needed for the channel compensation once the channel characteristic parameters {A,B,C,D} are estimated form the preamble as described herein. FIG. 12 is a simplified block diagram for performing channel estimation based on the preamble in accordance with one or more embodiments of the present invention. FIG. 13 is a simplified block diagram for performing channel compensation based on the channel parameters {A,B,C,D} from the channel estimation in accordance with one or more embodiments of the present invention. As shown in FIG. 13, the signals sin θₓ, −cos θₓ, sin θ_{y}, and −cos θ_{y} are the decoded received information. Embodiments of the invention described with respect to FIGS. 12 and 13 may be implemented hardware, software, or some combination thereof.

In those embodiments of the present invention in which direct dual stream mode is used, the channel compensation can be analogously performed with respect to that described for the pre-coding mode. Accordingly, the received signal can be formulated as in Equation (57):

$$[ \begin{matrix}{I}_{x} \\ {Q}_{x}\end{matrix} ] = [ \begin{matrix}A & 0 & 0 & B \\ 0 & C & D & 0\end{matrix} ] [ \begin{matrix}sin ( 2 π {f}_{c} t + {θ}_{x} ) \\ cos ( 2 π {f}_{c} t + {θ}_{x} ) \\ sin ( 2 π {f}_{c} t + {θ}_{y} ) \\ cos ( 2 π {f}_{c} t + {θ}_{y} )\end{matrix} ] \qquad ( 57 )$$

The uncompensated signal output from the down-conversion and LPF is shown in Equations (58)-(61):

II=LPF(I cos(2πf_{c}t))=A sin θₓ+B cos θ_{y} (58)

IQ=LPF(−I sin(2πf_{c}t))=−A cos θₓ+B sin θ_{y} (59)

QI=LPF(Q cos(2πf_{c}t))=C cos θₓ+D sin θ_{y} (60)

QQ=LPF(−Q sin(2πf_{c}t))=−D cos θ_{y}+C sin θₓ (61)

In the matrix form, Equations (58-61) can be expressed as Equation (62):

$$[ \begin{matrix}II \\ IQ \\ QI \\ QQ\end{matrix} ] = [ \begin{matrix}A & 0 & 0 & B \\ 0 & - A & B & 0 \\ 0 & C & D & 0 \\ C & 0 & 0 & - D\end{matrix} ] [ \begin{matrix}sin {θ}_{x} \\ cos {θ}_{x} \\ sin {θ}_{y} \\ cos {θ}_{y}\end{matrix} ] \qquad ( 62 )$$

which can be decoupled into two parts as Equations (63) and (64):

$$\begin{matrix}[ \begin{matrix}II \\ QI\end{matrix} ] = [ \begin{matrix}A & - B j \\ - C j & D\end{matrix} ] [ \begin{matrix}sin θ x \\ sin {θ}_{y}\end{matrix} ] & ( 63 ) \\ [ \begin{matrix}IQ \\ QQ\end{matrix} ] = [ \begin{matrix}- A & B j \\ C j & - D\end{matrix} ] [ \begin{matrix}cos {θ}_{x} \\ cos {θ}_{y}\end{matrix} ] & ( 64 )\end{matrix}$$

Then, we can recover

$$[ \begin{matrix}sin {θ}_{x} \\ sin {θ}_{y}\end{matrix} ] and [ \begin{matrix}cos {θ}_{x} \\ cos {θ}_{y}\end{matrix} ]$$

### as in Equations (65) and (66):

$$\begin{matrix}[ \begin{matrix}sin {θ}_{x} \\ sin {θ}_{y}\end{matrix} ] = \frac{1}{( AD + BC )} [ \begin{matrix}D & j B \\ j C & A\end{matrix} ] [ \begin{matrix}II \\ QI\end{matrix} ] & ( 65 ) \\ [ \begin{matrix}cos {θ}_{x} \\ cos {θ}_{y}\end{matrix} ] = \frac{1}{( AD + BC )} [ \begin{matrix}- D & - j B \\ - j C & - A\end{matrix} ] [ \begin{matrix}IQ \\ QQ\end{matrix} ] & ( 66 )\end{matrix}$$

The scaling factor

$$\frac{1}{( AD + BC )}$$

can be ignored.

Since j(II)=IQ and j(QI)=QQ, the baseband signals can be recovered as in Equations (67)-(70):

sin θₓ=D*II+B*QQ (67)

sin θ_{y}=C*IQ+A*QI (68)

cos θₓ=−D*IQ+B*QI (69)

cos θ_{y}=C*II−A*QQ (70)

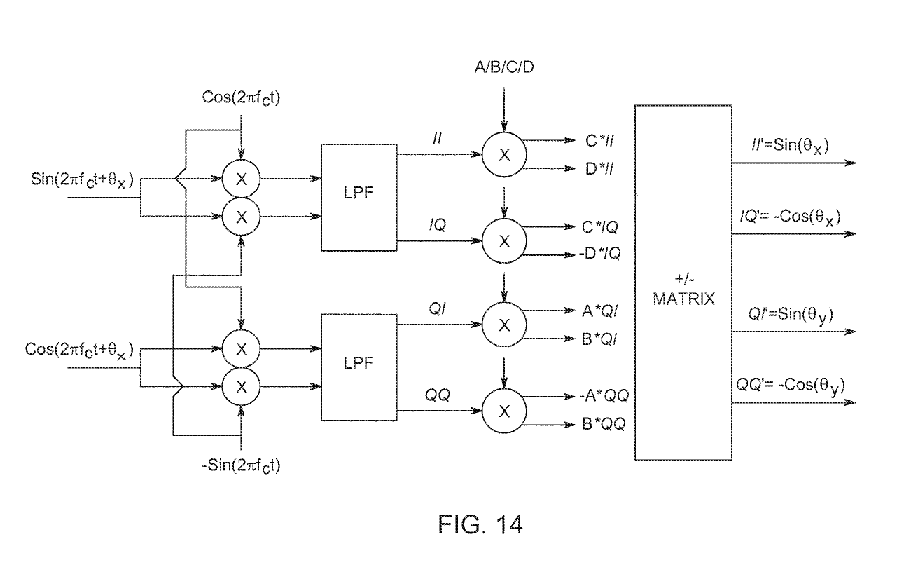

The resulting channel compensation for dual streams in the direct mode is depicted in FIG. 14, where the signals sin θₓ, −cos θₓ, sin θ_{y}, and −cos θ_{y} are the decoded received information.

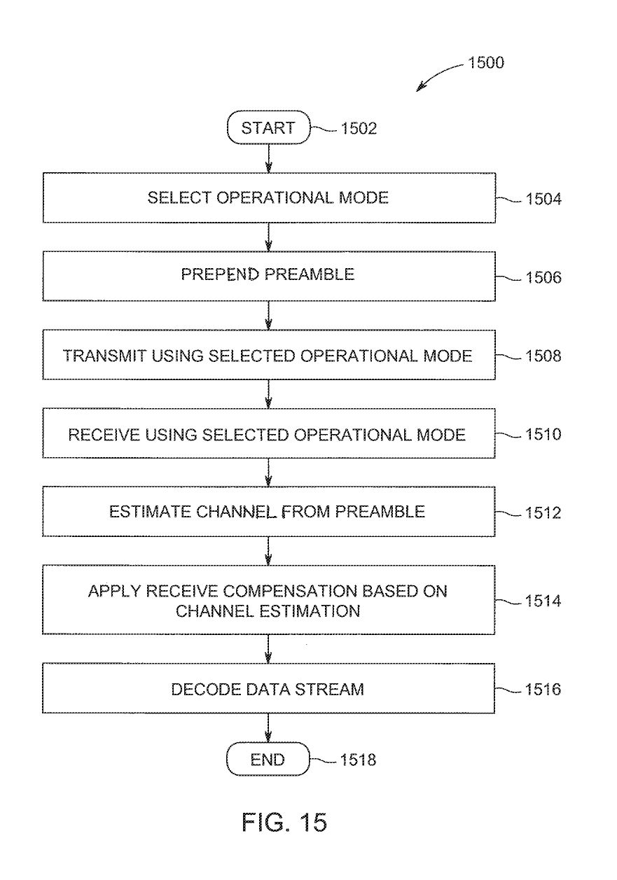

FIG. 15 is a flow diagram of a method 1500 for channel estimation and compensation for three-phase PLC in accordance with one or more embodiments of the present invention.

The method 1500 starts at step 1502 and proceeds to step 1504. At step 1504, an operational mode—e.g., a pre-coded dual stream mode or a direct dual stream mode—is determined. In some embodiments, the mode may be pre-determined based on the three phase PLC channel condition. At step 1506, the data packet preamble is created as previously described and prepended to the data packet. At step 1508, the data packet is transmitted via the three-phase PLC system using the selected operational mode. The method 1500 proceeds to step 1510, where the packet is received and down-converted based on the selected operational mode. At step 1512, the channel parameters A, B, C and D are determined from the preamble as previously described. At step 1514, compensation is applied to the received header and payload signals to recover the original transmitted signals. At step 1516, the recovered signals are decoded, and the method 1500 proceeds to step 1518 where it ends.

While the foregoing is directed to embodiments of the present invention, other and further embodiments of the invention may be devised without departing from the basic scope thereof, and the scope thereof is determined by the claims that follow.

1. A method for channel estimation for a three-phase communication system, comprising:
generating a first plurality of preamble patterns for use in a first data stream of two independent data streams;
generating a second plurality of preamble patterns for use in a second data stream of the two independent data streams;
transmitting the first and the second data streams via a communications channel comprising a three-wire three-phase system;
receiving a version of the first data stream comprising the first plurality of preamble patterns and a version of the second data stream comprising the second plurality of preamble patterns; and
generating, based on the received version of the first plurality of preamble patterns and the received version of the second plurality of preamble patterns, a channel estimation matrix for estimating the imbalance of the communications channel.

2. The method of claim 1, further comprising using the channel estimation matrix for compensating the received versions of the first and the second data streams to recover the first and the second data streams.

3. The method of claim 1, wherein transmitting the first and the second data streams comprises modulating the first and the second data streams onto the three-wire, three-phase system.

4. The method of claim 3, wherein the first and the second data streams are coupled to the three-wire, three-phase system by a first Scott-T transformer, and the received versions of the first and the second data streams are coupled to the three-wire, three phase system by a second Scott-T transformer.

5. The method of claim 1, wherein the imbalance of the communications channel comprises an amplitude imbalance and a phase imbalance.

6. The method of claim 1, further comprising performing precoding on the first and the second data streams prior to transmitting the first and the second data streams.

7. The method of claim 1, where the first and the second data streams are transmitted without any precoding.

8. The method of claim 1, wherein the three-wire three-phase system is a power line communications (PLC) system.

9. An apparatus for channel estimation for a three-phase communication system, comprising:
a transmitter for (i) generating a first plurality of preamble patterns for use in a first data stream of two independent data streams; (ii) generating a second plurality of preamble patterns for use in a second data stream of the two independent data streams; and (iii) transmitting the first and the second data streams via a communications channel comprising a three-wire three-phase system; and
a receiver for (iv) receiving a version of the first data stream comprising the first plurality of preamble patterns and a version of the second data stream comprising the second plurality of preamble patterns; and (v) generating, based on the received version of the first plurality of preamble patterns and the received version of the second plurality of preamble patterns, a channel estimation matrix for estimating the imbalance of the communications channel.

10. The apparatus of claim 9, where the receiver further uses the channel estimation matrix for compensating the received versions of the first and the second data streams to recover the first and the second data streams.

11. The apparatus of claim 9, wherein transmitting the first and the second data streams comprises modulating the first and the second data streams onto the three-wire, three-phase system.

12. The apparatus of claim 11, further comprising a first Scott-T transformer for coupling the first and the second data streams to the three-wire three-phase system, and a second Scott-T transformer for coupling the received versions of the first and the second data streams to the three-wire three phase system.

13. The apparatus of claim 9, wherein the imbalance of the communications channel comprises an amplitude imbalance and a phase imbalance.

14. The apparatus of claim 9, wherein the transmitter performs precoding on the first and the second data streams prior to transmitting the first and the second data streams.

15. The apparatus of claim 9, where the transmitter does not perform on first and the second data streams.

16. The apparatus of claim 9, wherein the three-wire three-phase system is a power line communications (PLC) system.

17. The apparatus of claim 12, wherein the transmitter and the first Scott-T transformer are components of a first power line communications transceiver (PLCT).

18. The apparatus of claim 17, wherein the first PLCT is a component of a power conditioning unit (PCU).

19. The apparatus of claim 18, wherein the receiver and the second Scott-T transformer are components of a second power line communications transceiver (PLCT).

20. The apparatus of claim 20, wherein the second PLCT is a component of a controller in a distributed generator (DG).
